(19) United States
(12) Patent Application Publication
(10) Pub. No.: US 2024/0221273 A1
(43) Pub. Date: Jul. 4, 2024

(54) PRESENTING ANIMATED SPATIAL EFFECTS IN COMPUTER-GENERATED ENVIRONMENTS

(71) Applicant: Apple Inc., Cupertino, CA (US)

(72) Inventors: James D. DUSSEAU, Santa Clara, CA (US); Tyson ERZE, Felton, CA (US); Fatima BROOM, San Francisco, CA (US)

(21) Appl. No.: 18/518,340

(22) Filed: Nov. 22, 2023

Related U.S. Application Data
(60) Provisional application No. 63/477,814, filed on Dec. 29, 2022.

(51) Int. Cl. G06T 13/60; G06F 3/01; G06T 13/40

(52) U.S. Cl. CPC G06T 13/60; G06F 3/011; G06T 13/40; G06T 2200/24

(57) ABSTRACT

Some examples of the disclosure are directed to presenting animated spatial effects within a computer-generated environment, such as an extended-reality environment. A communication associated with presenting a spatial effect may be received by an electronic device, and in response, the device may present the spatial effect with visual attributes that are selected by the device based on various criteria. Such visual attributes may include an emitting location, an emitting direction, a color, and/or a size of the spatial effect. The criteria used to select the visual attributes may include, for example, whether a representation of the sending user is displayed within the computer-generated environment, a direction of attention of the receiving user, and/or other criteria. Optionally, the spatial effect may include an audio portion with audio attributes that are also selected based on various criteria.

### CROSS-REFERENCE TO RELATED APPLICATIONS

This application claims the benefit of U.S. Provisional Application No. 63/477,814, filed Dec. 29, 2022, the content of which is hereby incorporated by reference in its entirety for all purposes.

### FIELD OF THE DISCLOSURE

This relates generally to systems and methods for presenting animated spatial effects in a computer-generated environment, such as an extended reality environment.

### BACKGROUND OF THE DISCLOSURE

Some computer systems are capable of presenting two-dimensional and/or three-dimensional computer-generated environments where at least some objects displayed for a user's viewing are virtual objects generated by the computer. A user of such a system may receive various communications from other users, such as text messages.

### SUMMARY OF THE DISCLOSURE

Systems and methods for presenting spatial effects within a three-dimensional computer-generated environment, such as an extended reality (XR) environment, are disclosed. Such spatial effects may include, for example, confetti, bubbles, star showers, balloons, fireworks, or other types of spatial effects.

An electronic device displaying a computer-generated environment may receive a communication (e.g., a text message or other type of communication) from a device of a sending user, where the communication is associated with presenting a spatial effect. In response to receiving the communication, the electronic device may present the spatial effect with various visual and audio attributes. Visual attributes may include, for example, one or more emitting locations (e.g., location(s) within in the computer-generated environment from which the spatial effect appears to originate), one or more emitting directions (e.g., the direction(s) in which elements of the spatial effect initially move after originating from the emitting location(s)), a color (e.g., a brightness level, opacity, and/or tone), a size (e.g., the size of each element of the spatial effect and/or the size of the area or volume occupied by all of the elements of the spatial effect as they move through the environment), and/or a persistence of the spatial effect (e.g., a duration of time during which the spatial effect is displayed and/or whether elements of the spatial effect interact with objects in the computer-generated environment), among other possibilities.

In some embodiments, the visual attributes and/or audio attributes for presenting the spatial effect are selected (e.g., varied) by the electronic device based on various criteria. Such criteria can include, for example, whether a representation of the sending user (e.g., an avatar) is visible to and/or in the line of sight of the receiving user of the electronic device, whether the receiving user is viewing media content within the computer-generated environment, what type of communication initiated the spatial effect, an immersion level of the receiving user, whether the receiving device is operating in a notification-suppression mode (e.g., a “do not disturb” mode), and/or other criteria.

One or more of these criteria may be used to determine how, where, and/or when the spatial effect is presented to the receiving user. For example, such criteria may be used to determine how to present a spatial effect in a manner that (1) conveys the identity of the sending user, (2) does not unduly distract the receiving user, and/or (3) appears realistic within the computer-generated environment.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality (XR) environment according to some examples of the disclosure.

FIG. 2 illustrates a block diagram of an exemplary electronic device according to some examples of the disclosure.

FIGS. 3A-3L illustrate examples of presenting animated spatial effects in a computer-generated environment according to some examples of the disclosure.

FIG. 4 illustrates a flow diagram of an example process for presenting animated spatial effects in a computer-generated environment according to some examples of the disclosure.

### DETAILED DESCRIPTION

Some examples of the disclosure are directed to systems and methods for presenting spatial effects within a three-dimensional computer-generated environment, such as an extended reality (XR) environment. Such spatial effects may include, for example, confetti, bubbles, star showers, balloons, fireworks, or other types of spatial effects. Such spatial effects may be used to convey an emotion or reaction of the sender of the spatial effect, for example. In some embodiments, spatial effects are visually presented as two-dimensional or three-dimensional animated effects (e.g., effects that have a two-dimensional or three-dimensional spatial aspect and are non-stationary). In some embodiments, spatial effects include multiple elements, such as multiple pieces of confetti, multiple balloons, multiple stars, etc. In some embodiments, spatial effects may be presented as having motion that conforms to one or more laws of physics, such as motion that appears to be affected by gravity, inertia, momentum, etc. Spatial effects may include a visual portion and, optionally, an audio portion. For example, a fireworks spatial effect may include an audio portion that simulates the sound of fireworks.

A first device that is presenting a computer-generated environment to a first user may receive a communication from a second device (e.g., corresponding to a second user), where the communication is associated with a spatial effect to be presented on the first device. The first user may be referred to as a receiving user, and the second user may be referred to as a sending user. The communication may be a text message, an audio message, an indication of a gesture made by the second user (such as a wave, a thumbs-up gesture, etc.), or another type of communication, for example. In some embodiments, the communication may include text or other communication content. In some embodiments, the communication may include only a request to present the spatial effect, without (e.g., excluding) additional text or other communication content. In response to receiving, from the second device, the communication associated with presenting the spatial effect, the first device may present, in the computer-generated environment, the spatial effect to the receiving user.

The spatial effect may be presented with various visual and audio attributes. Visual attributes may include, for example, one or more emitting locations (e.g., the location(s) within in the computer-generated environment from which the spatial effect appears to emanate), one or more emitting directions (e.g., the direction(s) in which the spatial effect initially moves after originating from the emitting location(s), a color (e.g., a brightness level, opacity, and/or tone), a size (e.g., the size of each element of the spatial effect and/or the size of the area or volume occupied by all of the elements of the spatial effect as they move through the computer-generated environment), and/or a persistence of the spatial effect (e.g., a duration of time during which the spatial effect is displayed and/or whether elements of the spatial effect interact with objects in the computer-generated environment), among other possibilities. Similarly, audio attributes of the spatial effect may include an emitting location and/or a volume. In some embodiments, an audio portion of a spatial effect may be presented with acoustic characteristics that simulate the acoustics of the computer-generated environment and are based on the emitting location of the audio portion of the spatial effect.

In some embodiments, the visual attributes and/or audio attributes of a spatial effect are selected (e.g., varied) by the receiving device based on various criteria. Such criteria can include, for example:
Whether a representation of the sending user is visible to and/or in the line of sight of the receiving user;
The type of communication that initiated the spatial effect (e.g., whether the spatial effect was initiated by a text message, a detected gesture, or another type of communication);
An immersion level of the receiving user (e.g., whether the receiving user is fully or mostly immersed in a virtual environment that is displayed in the computer-generated environment, such as a gaming environment);
An operating mode of the receiving device (e.g., whether the receiving device is operating in a notification-suppression mode, such as a “do not disturb” mode, in which the receiving device suppresses presentation of notifications);
A direction of attention of the receiving user (e.g., whether the receiving user is watching media content, looking at or interacting with an application user interface, and/or looking at a virtual object in the computer-generated environment);
A number of other users (if any) that are participating in a multi-user communication session (e.g., a shared virtual experience) with the receiving user;
Spatial constraints associated with the computer-generated environment, such as the location of virtual objects or walls within the computer-generated environment; and/or
A lighting characteristic of the computer-generated environment, such as a time of day associated with the computer-generated environment or lighting sources in the computer-generated environment.

One or more of these criteria (and/or additional criteria) may be used to determine how, where, and/or when the spatial effect is presented to the receiving user. For example, such criteria may be used to determine how to present a spatial effect in a manner that (1) conveys the identity of the sending user, (2) does not unduly distract the receiving user, and/or (3) appears realistic within the computer-generated environment. In some embodiments, such criteria may be used to determine whether to temporarily or permanently suppress presentation of the spatial effect. In some embodiments, such criteria may also be used to determine whether to present an identifier of the sending user with the spatial effect.

Examples of using various criteria that may be used to determine various visual and audio attributes of spatial effects to be presented within a computer-generated environment, and/or whether to suppress presentation of a spatial effect, are described herein. Such examples are not exhaustive, and the criteria described herein can be combined in different ways to determine how, where, and when to present a spatial effect.

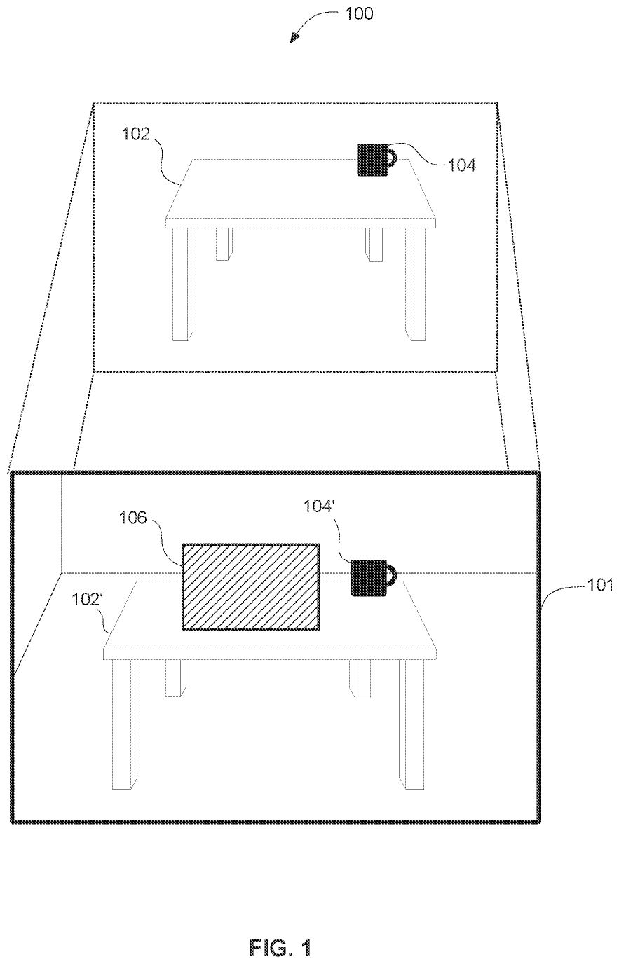

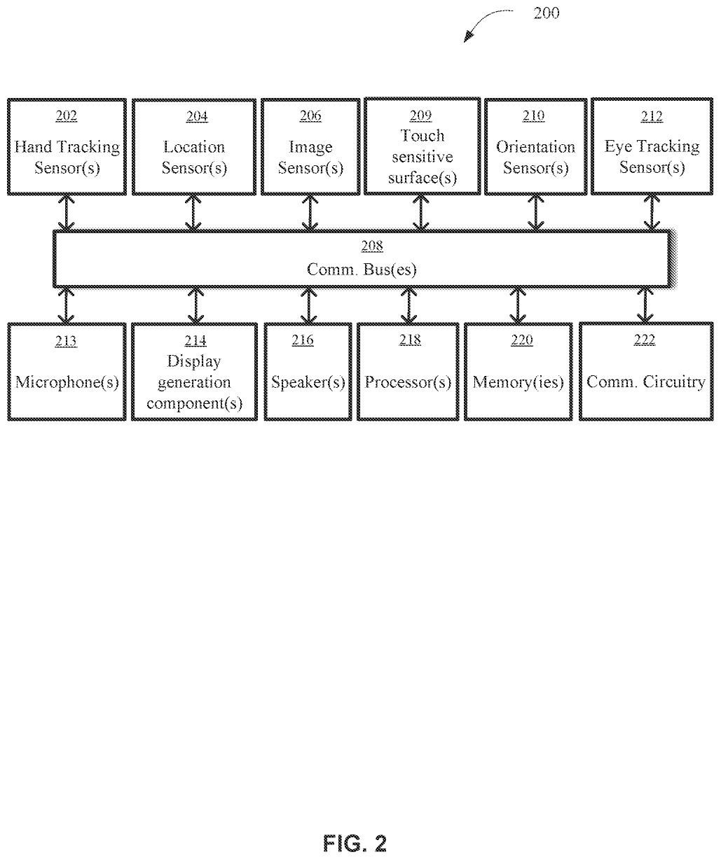

FIG. 1 illustrates an electronic device 101 presenting an extended reality (XR) environment (e.g., a computer-generated environment) according to some examples of the disclosure. In some embodiments, electronic device 101 is a hand-held or mobile device, such as a tablet computer, laptop computer, smartphone, head-mounted or eye-mounted display systems, projection-based systems (including hologram-based systems), or other suitable device. Examples of electronic device 101 are described below with reference to the block diagram of FIG. 2. As shown in FIG. 1, electronic device 101, table 102, and coffee mug 104 are located in the physical environment 100. In some embodiments, electronic device 101 may be configured to capture images of physical environment 100 including table 102 and coffee mug 104 (illustrated in the field of view of electronic device 101). In some embodiments, real-world objects may be viewed directly through a transparent or translucent display. Representations of such real-world objects, such as a representation 102′ of real-world table 102 and a representation 104′ of real-world coffee mug 104, may be displayed in the computer-generated environment. Representations of real-world objects may be virtual representations of the real-world objects that are generated by electronic device 101 (e.g., based on image captures of real-world objects) or may be real-world objects that are viewed directly through a transparent or translucent display and presented alongside virtual content within the computer-generated environment.

In some embodiments, in response to a trigger, the electronic device 101 may be configured to display a virtual object (e.g., a two- or three-dimensional virtual object) in the computer-generated environment. For example, rectangular virtual object 106 is not present in the physical environment 100, but is displayed in the computer-generated environment positioned on (e.g., anchored to) the top of the representation 102′ of real-world table 102. For example, virtual object 106 can be displayed on the surface of the representation 102′ of the table in the computer-generated environment next to the representation 104′ of real-world coffee mug 104 displayed via device 101 in response to detecting the planar surface of the real-world table 102 in the physical environment 100.

It should be understood that virtual object 106 is a representative virtual object and one or more different virtual objects (e.g., of various dimensionality such as two-dimensional or three-dimensional virtual objects) can be included and rendered in a three-dimensional computer-generated environment. In some embodiments, a virtual object can represent an application or a user interface displayed in the computer-generated environment. In some embodiments, a virtual object can represent content corresponding to the application and/or displayed via the user interface in the computer-generated environment. In some embodiments, a location of virtual object 106 and/or the locations of representations of real-world objects (e.g., representations 102′, 104′) may be used, by the electronic device 101, to help determine an emitting location(s) and/or emitting direction(s) of a spatial effect such that the spatial effect is not emitted from a location or in a direction that conflicts with the location of the virtual object 106 and/or the locations of computer-generated representations of real-world objects. That is, the emitting location(s) and/or emitting direction(s) of a spatial effect may be based in part on the locations of virtual object(s) 106 and/or the locations of real-world objects or computer-generated representations of real-world objects in the computer-generated environment such that the spatial effect appears realistic and does not appear to emanate from within walls and/or objects in the computer-generated environment.

In some embodiments, spatial characteristics of objects presented within the computer-generated environment (e.g., virtual objects, real-world objects, and/or computer-generated representations of real-world objects) may be used to help determine the emitting location(s), emitting direction(s), persistence, and/or size of the spatial effect such that elements of the spatial effect appear to be in proportion to nearby objects and to behave in a manner that conforms to one or more laws of physics (such as by gathering on surfaces of objects and/or being deflected by objects). Such spatial characteristics may include, for example, whether objects appear to be two-dimensional (such as a virtual display screen) or three-dimensional (such as a table) and/or whether the object includes a surface onto which elements of a spatial effect may fall based on simulated gravity.

In some examples, virtual object 106 may be displayed within a multi-user communication session (“multi-user communication session,” “communication session”), in which multiple users are viewing the same or similar computer-generated environments.

In the discussion that follows, an electronic device that is in communication with a display generation component is described. It should be understood that the electronic device optionally is in communication with one or more physical user-interface devices that may detect various user inputs, such as touch-sensitive surface, a physical keyboard, a mouse, a joystick, a hand tracking device, an eye tracking device, a stylus, etc.

The electronic device may support a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, a digital video player application, and/or a social media application.

FIG. 2 illustrates a block diagram of an exemplary electronic device 200 according to some examples of the disclosure.

In some embodiments, electronic device 200 is a hand-held or mobile device, such as a tablet computer, laptop computer, smartphone, head-mounted or eye-mounted display systems, projection-based systems (including hologram-based systems), such as electronic device 101.

As illustrated in FIG. 2, the electronic device 200 optionally includes various sensors (e.g., one or more hand tracking sensor(s) 202, one or more location sensor(s) 204, one or more image sensor(s) 206, one or more touch-sensitive surface(s) 209, one or more motion and/or orientation sensor(s) 210, one or more eye tracking sensor(s) 212, one or more microphone(s) 213 or other audio sensors, etc.), one or more display generation component(s) 214, one or more speaker(s) 216, one or more processor(s) 218, one or more memories 220, and/or communication circuitry 222.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®. Optionally, electronic device 200 may communicate with another device similar to electronic device 200, such as when electronic device 200 and one or more other devices are participating in a shared computer-generated environment.

Processor 218 includes one or more general processors, one or more graphics processors, and/or one or more digital signal processors. In some embodiments, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some embodiments, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

In some embodiments, display generation component 214 includes a single display (e.g., a liquid-crystal display (LCD), organic light-emitting diode (OLED), or other types of display). In some embodiments, display generation component 214 includes multiple displays. In some embodiments, display generation component 214 can include a display with touch capability (e.g., a touch screen), a projector, a holographic projector, a retinal projector, etc. In some embodiments, electronic device 200 includes touch-sensitive surface 209 for receiving user inputs, such as tap inputs and swipe inputs or other gestures. In some embodiments, display generation component 214 and touch-sensitive surface 209 form touch-sensitive display(s) (e.g., a touch screen integrated with electronic device 200, respectively, or an external device that is in communication with electronic device 200.

Electronic device 200 optionally includes image sensor(s) 206. Image sensors(s) 206A optionally includes one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally includes one or more infrared (IR) sensors, such as a passive or an active IR sensor, for detecting infrared light from the real-world environment. For example, an active IR sensor includes an IR emitter for emitting infrared light into the real-world environment. Image sensor(s) 206A also optionally include one or more cameras configured to capture movement of physical objects in the real-world environment. Image sensor(s) 206 also optionally includes one or more depth sensors configured to detect the distance of physical objects from electronic device 200. In some embodiments, information from one or more depth sensors can allow the device to identify and differentiate objects in the real-world environment from other objects in the real-world environment. In some embodiments, one or more depth sensors can allow the device to determine the texture and/or topography of objects in the real-world environment.

In some embodiments, electronic device 200 uses CCD sensors, event cameras, and depth sensors in combination to detect the physical environment around electronic device 200. In some embodiments, image sensor 206 includes a first image sensor and a second image sensor. The first image sensor and the second image sensor work in tandem and are optionally configured to capture different information of physical objects in the real-world environment. In some embodiments, the first image sensor is a visible light image sensor and the second image sensor is a depth sensor. In some embodiments, electronic device 200 uses image sensor(s) 206 to detect the position and orientation of electronic device 200 and/or display generation component(s) 214 in the real-world environment. For example, electronic device 200 uses image sensor(s) 206 to track the position and orientation of display generation component(s) 214 relative to one or more fixed objects in the real-world environment.

In some embodiments, electronic device 200 includes microphone(s) 213 or other audio sensors. Electronic device 200 uses microphone(s) 213 to detect sound from the user and/or the real-world environment of the user. In some embodiments, microphone(s) 213 includes an array of microphones (a plurality of microphones) that optionally operate in tandem, such as to identify ambient noise or to locate the source of sound in space of the real-world environment.

Electronic device 200 includes location sensor(s) 204 for detecting a location of electronic device 200 and/or display generation component(s) 214. For example, location sensor(s) 204 can include a GPS receiver that receives data from one or more satellites and allows electronic device 200 to determine the device's absolute position in the physical world.

Electronic device 200 includes orientation sensor(s) 210 for detecting orientation and/or movement of electronic device 200 and/or display generation component(s) 214. For example, electronic device 200 uses orientation sensor(s) 210 to track changes in the position and/or orientation of electronic device 200 and/or display generation component(s) 214, such as with respect to physical objects in the real-world environment. Orientation sensor(s) 210 optionally include one or more gyroscopes and/or one or more accelerometers.

Electronic device 200 includes hand tracking sensor(s) 202 and/or eye tracking sensor(s) 212, In some embodiments. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some embodiments, hand tracking sensor(s) 202 and/or eye tracking sensor(s) 212 are implemented together with the display generation component(s) 214. In some embodiments, the hand tracking sensor(s) 202 and/or eye tracking sensor(s) 212 are implemented separately from the display generation component(s) 214.

In some embodiments, the hand tracking sensor(s) 202 can use image sensor(s) 206 (e.g., one or more IR cameras, 3D cameras, depth cameras, etc.) that capture three-dimensional information from the real world including one or more hands (e.g., of a human user). In some embodiments, the hands can be resolved with sufficient resolution to distinguish fingers and their respective positions. In some embodiments, one or more image sensor(s) 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some embodiments, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some embodiments, both eyes are tracked separately by respective eye tracking cameras and illumination sources, and a focus/gaze can be determined from tracking both eyes. In some embodiments, one eye (e.g., a dominant eye) is tracked by a respective eye tracking camera/illumination source(s).

Electronic device 200 is not limited to the components and configuration of FIG. 2, but can include fewer, other, or additional components in multiple configurations. A person or persons using electronic device 200, is optionally referred to herein as a user or users of the device(s). Attention is now directed towards exemplary techniques for displaying spatial effects in a computer-generated environment.

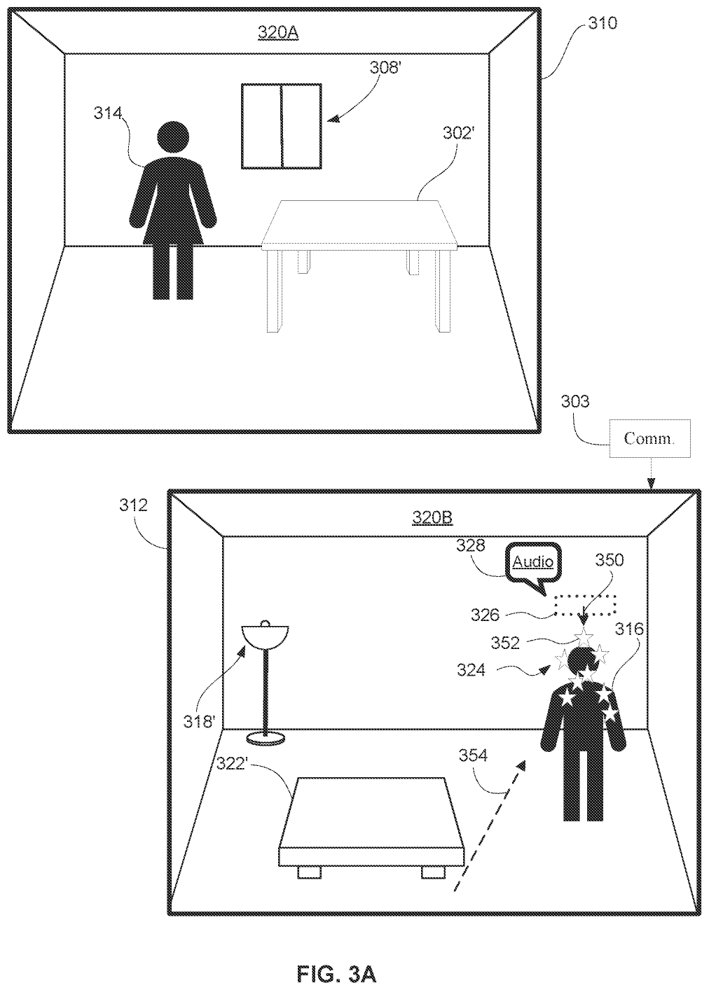

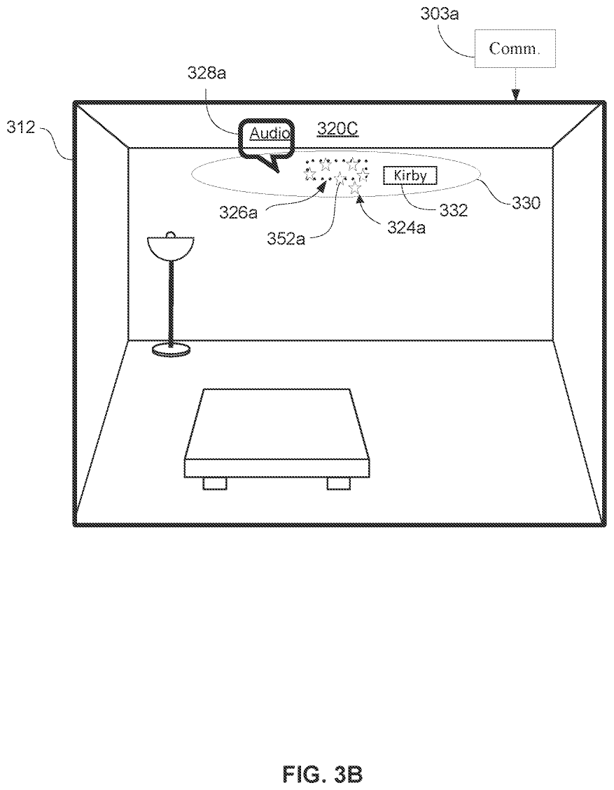

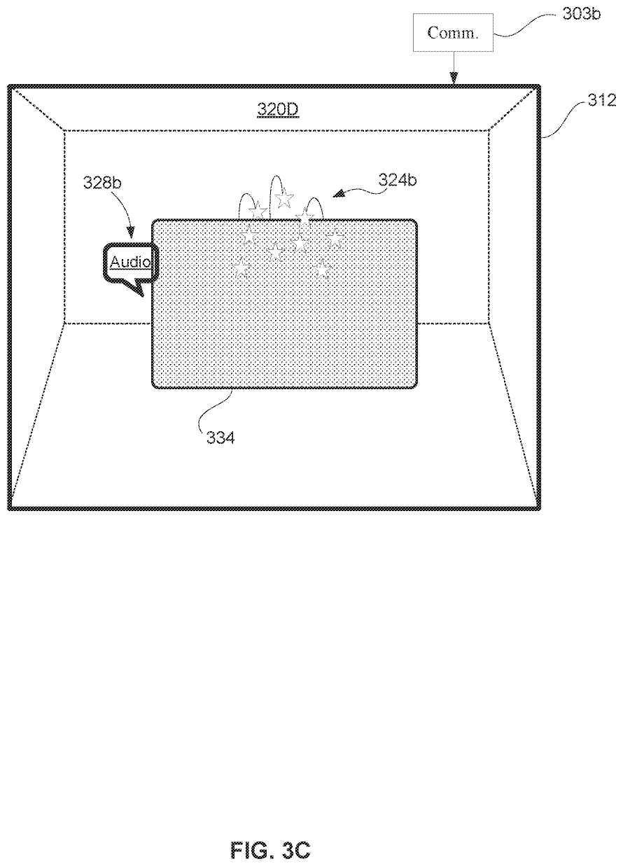

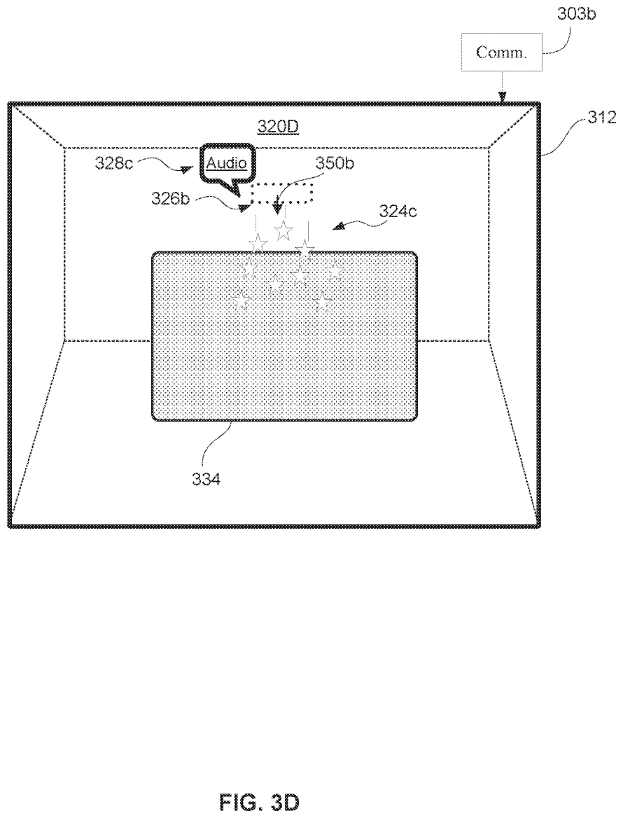

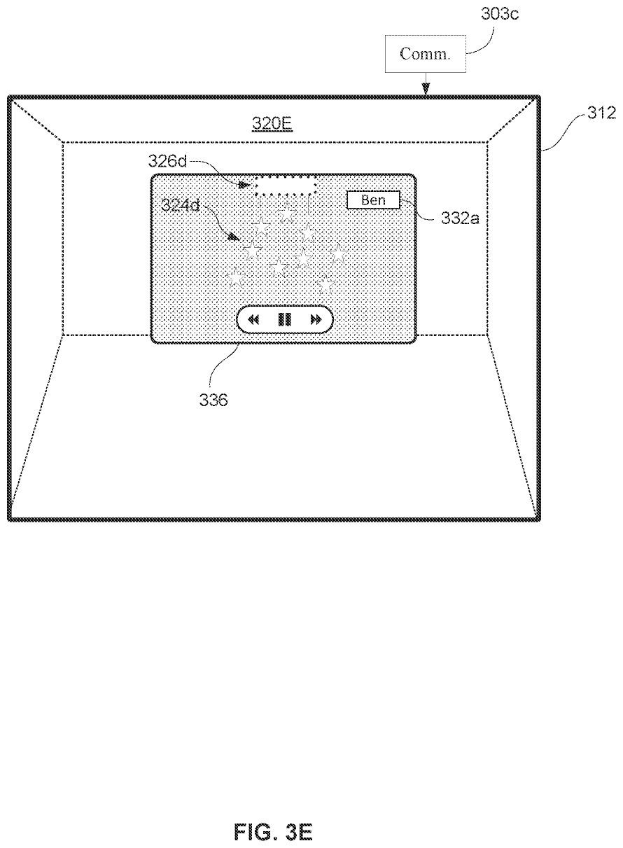

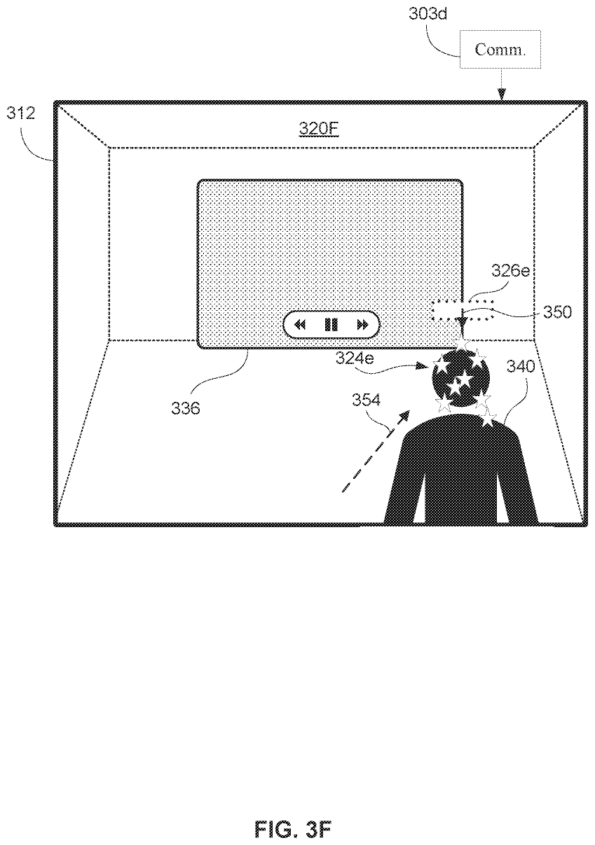

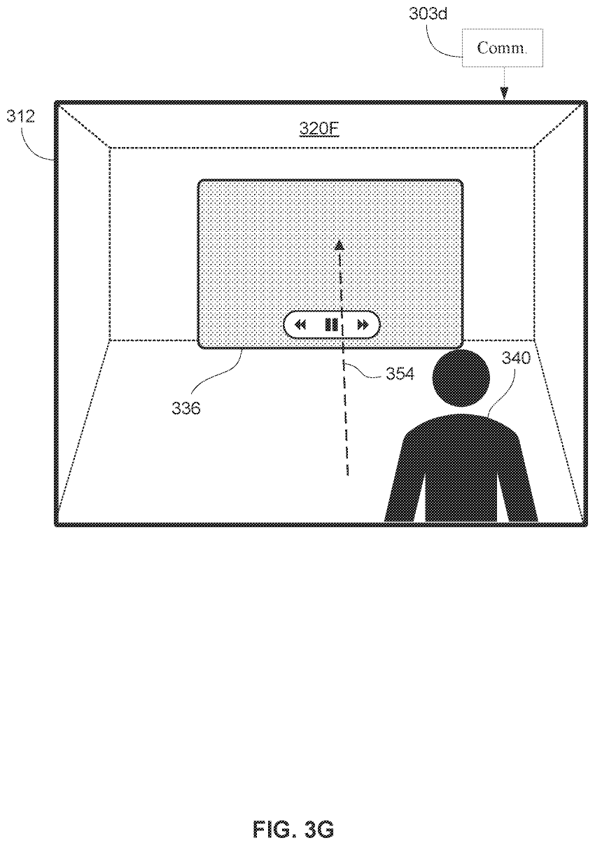

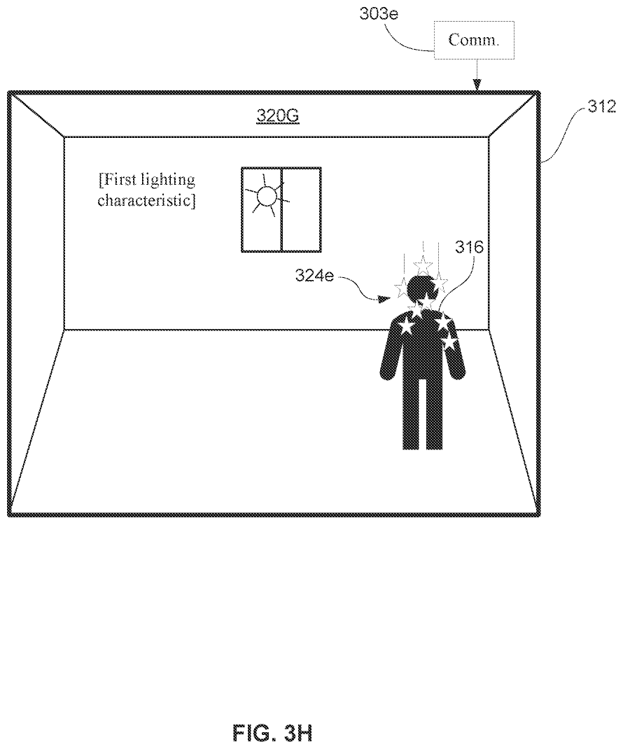

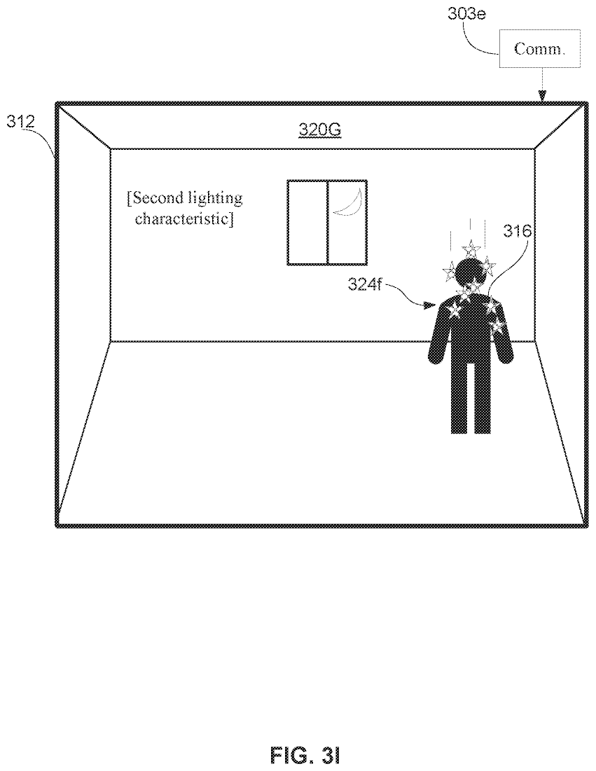

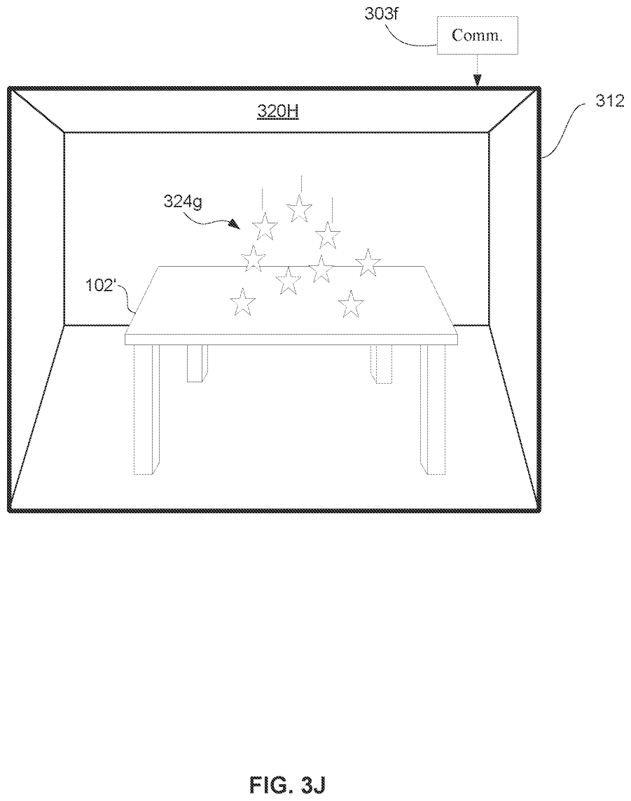

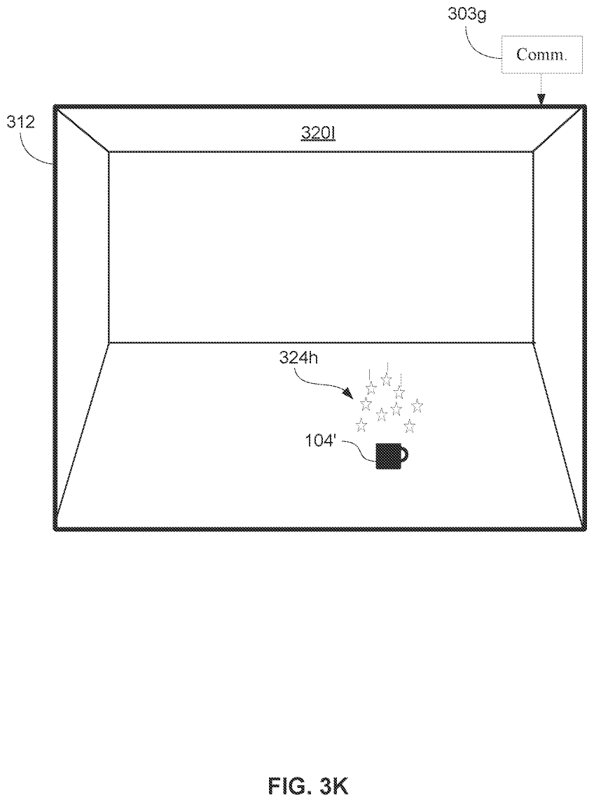

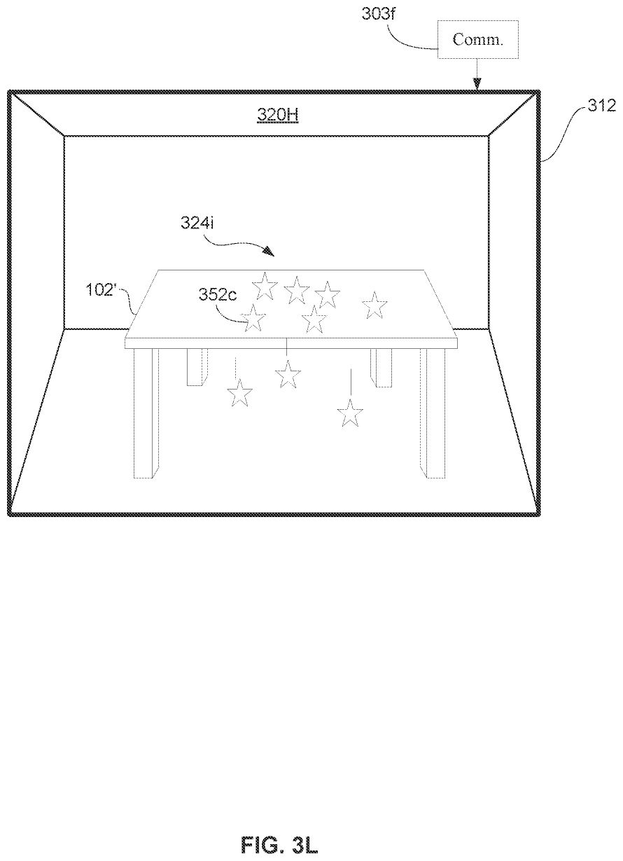

FIG. 3A illustrates an example of presenting an animated spatial effect in a computer-generated environment according to some examples of the disclosure.

In the example of FIG. 3A, two electronic devices, electronic device 310 and electronic device 312, are participating in a multi-user communication session. In some embodiments, a first electronic device 310 may present a three-dimensional computer-generated environment 320A representing a field of view of a first user, and a second electronic device 312 may present a three-dimensional computer-generated environment 320B representing a field of view of a second user. The first electronic device 310 and the second electronic device 312 may be similar to device 101 or 200, and/or may be a head mountable system/device and/or projection-based system/device (including a hologram-based system/device) configured to generate and present a computer-generated environment, such as, for example, heads-up displays (HUDs), head mounted displays (HMDs), windows having integrated display capability, and/or displays formed as lenses designed to be placed on a person's eyes (e.g., similar to contact lenses).

In the example of FIG. 3A, the first user (not shown) is optionally wearing the electronic device 310 and the second user (not shown) is optionally wearing the electronic device 312, such that the three-dimensional computer-generated environment 320A/320B can be defined by X, Y and Z axes as viewed from a perspective of the electronic devices (e.g., a viewpoint associated with the electronic device 310/312, which may be a head-mounted display, for example).

Electronic device 310 may be in a first physical environment that includes a table and a window. Thus, the computer-generated environment 320A presented using electronic device 310 optionally includes captured portions of the physical environment surrounding the electronic device 310, such as a representation of the table 302′ and a representation of the window 308′. Similarly, the electronic device 312 may be in a second physical environment, different from the first physical environment (e.g., separate from the first physical environment), that includes a floor lamp and a coffee table. Thus, the computer-generated environment 320B presented using the electronic device 312 optionally includes captured portions of the physical environment surrounding the electronic device 312, including a representation of the floor lamp 318′ and a representation of the coffee table 322′. Additionally, the computer-generated environments 320A and 320B may include representations of the floor, ceiling, and walls of the rooms in which the first electronic device 310 and the second electronic device 312, respectively, are located.

In some embodiments, while the first electronic device 310 is in the multi-user communication session with the second electronic device 312, a representation of the user of one electronic device is optionally displayed in the computer-generated environment that is displayed via the other electronic device. The representation of the user may be or may include a graphical element, a photo, a symbol, a video, an avatar, or another type of user-provided or computer-generated representation of the user. For example, as shown in FIG. 3A, at the first electronic device 310, an avatar 314 corresponding to the user of the second electronic device 312 is displayed in the computer-generated environment 320A. Similarly, at the second electronic device 312, an avatar 316 corresponding to the user of the first electronic device 310 is displayed in the computer-generated environment 320B. Thus, each user can see an avatar representing the other user in the computer-generated environment. In some embodiments, each user may also be represented by an avatar (not shown) in the field of view of their own device such that each user can see an avatar representing themselves.

In the example depicted in FIG. 3A, the first user (e.g., the user of device 310, represented by avatar 316) has sent a communication 303 (e.g., a text message or another type of communication) to the second user (e.g., the user of device 312) that is associated with presenting a spatial effect. That is, device 312 has received, from device 310, a communication 303 associated with presenting a spatial effect. In the example depicted in FIG. 3A (and in subsequent examples), the type of spatial effect associated with the communication is an animated star shower, but it should be understood that the type of spatial effect associated with the communication may be, for example, animated confetti, fireworks, balloons, or any other type of animated effect.

In some embodiments, the communication 303 may include an explicit indication of the type of spatial effect (e.g., confetti, fireworks, balloons, etc.) to be presented. For example, the sending user may select the type of spatial effect from a menu, and the communication 303 may include an indication of the selected type of spatial effect. In some embodiments, the type of spatial effect to be presented may be identified implicitly by device 310 or device 312 based on the content of the communication. For example, if communication 303 includes the text “Happy Fourth of July,” device 310 or device 312 may identify (e.g., select) a spatial effect type of fireworks based on the text.

In response to receiving the communication 303, device 312 may determine whether certain criteria are satisfied, and may present the spatial effect with various visual and/or audio attributes based on a determination that certain criteria are satisfied. In some embodiments, the criteria includes a first criterion that is satisfied when the user of device 310 (e.g., the sending user) is represented in the computer-generated environment 320B (e.g., by an avatar or other representation) of the user of device 312 (e.g., the receiving user), such as when a representation of the user of device 310 is partially or fully visible to the user of device 312 (e.g., the receiving user) within the computer-generated environment 320B (e.g., is partially or fully displayed by device 312) and/or within a line of sight 354 of the user of device 312. The line of sight of the user of device 312 may be determined via information received from eye-tracking sensors and/or based on an orientation of device 312, or by other means.

As shown in FIG. 3A, avatar 316, which provides a representation of the sending user (e.g., the user of device 310), is displayed by device 312 within the computer-generated environment 320B and in addition, avatar 316 is in the line of sight 354 of the receiving user. Thus, the first criterion is satisfied. Various visual and/or audio attributes may be selected by device 312 for presenting the spatial effect based on the satisfaction of the first criterion.

For example, in some embodiments, in response to receiving communication 303 and based on a determination that a representation of the sending user (e.g., avatar 316) is displayed by device 312 within the computer-generated environment 320B and can therefore be viewed by the receiving user (e.g., on device 312), and/or based on a determination that the representation of the sending user is in the line of sight 354 of the receiving user, device 312 may select an emitting location within the computer-generated environment 320B based on the location of the representation of the sending user (e.g., based on the location of avatar 316). For example, device 312 may select an emitting location 326 (conceptually represented in FIG. 3A by a dashed rectangle that is not displayed in computer-generated environment 320B) that is within a threshold distance of the representation of the sending user, such as within 0.1, 0.2, 0.3, 0.4, 0.5. 0.6, 0.7, 0.8, 0.9, or 1.0 meters above, behind, below, in front of, or adjacent to avatar 316.

Device 312 may then present a visual portion 324 of the spatial effect with the selected emitting location 326.

In some embodiments, device 312 may also select an emitting direction 350 of the visual portion 324 of the spatial effect such that elements 352 of the visual portion 324 of the spatial effect may appear to move towards and/or make contact with the representation of the sending user as the elements 352 move away from the emitting location 326 in the computer-generated environment 320B.

The emitting location 326 may be a virtual location (or area) from which the visual portion 324 of the spatial effect (e.g., including one or more animated elements 352 of the spatial effect) appears to emanate. The emitting direction 350 (represented as a downward arrow in FIG. 3A, which is not displayed in computer-generated environment 320B) may be selected by device 312 based on the emitting location 326 and/or based on the location of avatar 316, and may specify a direction of an animated path along which the elements 352 of the visual portion 324 of the spatial effect travel within the computer-generated environment 320B. In some embodiments, if the emitting location 326 is selected to be near an avatar 316, the visual portion 324 (e.g., including one or more elements 352) of the spatial effect may appear to make contact with the avatar 316 as it travels along a path within the computer-generated environment 320B.

As previously discussed, in the example of FIG. 3A, device 312 selects an emitting location 326 that is above avatar 316 and an emitting direction 350 that is in the direction of avatar 316 (e.g., downwards from emitting location 326) such that elements of the visual portion 324 of the spatial effect may appear to fall onto and/or make contact with avatar 316. In other examples, device 312 may select a different emitting location and/or emitting direction, such as an emitting location that is behind a lower portion of avatar 316 and an emitting direction that points upward and toward avatar 316 such that elements 352 of the visual portion 324 of the spatial effect will appear to initially move above avatar 316 and then fall down onto avatar 316 in accordance with simulated gravity.

Presenting the spatial effect in this manner, with an emitting location and/or emitting direction that is/are selected based on the location of the representation of the sending user (e.g., near an avatar of the sending user and/or in the direction of the avatar of the sending user), provides an indication to the receiving user of the sender user's identity.

In addition to the visual portion 324 of the spatial effect, a spatial effect may also include an accompanying audio portion 328 that is audible to the user of device 312. In accordance with a determination that certain criteria are satisfied (which may be the same as or different from the criteria used to determine the visual attributes of the spatial effect), an audio portion 328 of the spatial effect may be presented with one or more audio attributes that are selected based on which criteria are satisfied. Such audio attributes may include an emitting location, for example. As shown in FIG. 3A, an audio portion 328 of the spatial effect may be presented with the same emitting location 326 as the visual portion 324 of the spatial effect, such that it sounds to the receiving user as though the audio portion is emanating from the same emitting location 326 as the visual portion 324 of the spatial effect. In some embodiments, an emitting location(s) of the audio portion 328 of a spatial effect may be different from the emitting location(s) of the visual portion 324 of the spatial effect. For example, an audio portion 328 of a spatial effect may be emitted from one or more emitting locations that simulate acoustic effects of the computer-generated environment, such as by using audio emitting locations throughout the computer-generated environment to simulate an echo effect.

It should be understood that, in some embodiments, more than two electronic devices may be communicatively linked in a multi-user communication session. For example, if three electronic devices are communicatively linked in a multi-user communication session, one electronic device may display two avatars, rather than just one avatar, corresponding to the users of the other two electronic devices. In some embodiments, the various processes and exemplary interactions described herein with reference to the first electronic device 310 and the second electronic device 312 in a multi-user communication session optionally apply to situations in which more than two electronic devices are communicatively linked in a multi-user communication session. In some embodiments, if representations of two or more users (including the sending user and one or more additional users) are visible within the computer-generated environment of a receiving device (e.g., an electronic device that receives a communication associated with presenting a spatial effect), the receiving device may select the visual attributes and/or audio attributes of the spatial effect (e.g., emitting location, emitting direction, etc.) based on the location of the representation of the sending user and also based on the location of the representation(s) of the one or more additional users. For example, the receiving device may select an emitting location that is closer to the representation of the sending user than to the representations of the additional users, and/or may select an emitting direction that is in the direction of the representation of the sending user.

In some embodiments, the one or more criteria include a criterion that is satisfied when there are fewer than a threshold quantity (e.g., 3, 4, 5, 6, 7, or 8) of electronic devices communicatively linked in a multi-user communication session. In some embodiments, if there are more than the threshold quantity of electronic devices that are communicatively linked in a multi-user communication session, presentation of the spatial effect may be temporarily or permanently suppressed by the receiving device (e.g., the receiving device may not present the spatial effect in response to receiving the communication associated with presenting the spatial effect).

FIG. 3B illustrates an example of presenting a spatial effect in a computer-generated environment according to some examples of the disclosure.

In the previous example of FIG. 3A, an avatar 316 of the sending user is displayed by the receiving device 312 within the computer-generated environment 320B, and as a result of satisfying this criterion, the spatial effect is presented with an emitting location that is near the avatar of the sending user. In some embodiments, if a representation of the sending user is not displayed by the receiving device within the computer-generated environment and/or is not within the line of sight of the receiving user, as may be the case if the sending user is not participating in a multi-user communication session with the receiving user, or if the receiving user is looking away from the representation of the sending user, the spatial effect may be presented with different visual attributes and/or audio attributes relative to the example shown in FIG. 3A.

For example, in response to receiving a communication associated with presenting a spatial effect and in accordance with a determination that a representation of the sending user of communication is not visible within the computer-generated environment, a device may select different visual attributes and/or audio attributes for presenting the spatial effect relative to the case when a representation of the sending user is visible to the receiving user within the computer-generated environment. That is, in response to receiving the communication and in accordance with a determination that one or more second criteria are satisfied, which may include a criterion that is satisfied when a representation of the user who sent the communication is not displayed in the computer-generated environment and/or is not in the line of sight of the receiving user, the device may present the spatial effect with different visual and/or audio attributes relative to the case when a representation of the sending user is displayed and/or is in the line of sight of the receiving user, such as with a different emitting location, emitting direction, color, and/or size.

In the example of FIG. 3B, in accordance with a determination that a representation of the sending user is not displayed by device 312 within computer-generated environment 320C, a spatial effect (including a visual portion 324a and, optionally, an audio portion 328a) is presented with an emitting location 326a within a notifications region 330 of the computer-generated environment 320C. In some embodiments, the notifications region 330 is a predefined region of the computer-generated environment 320C in which notifications associated with one or more applications are presented. Such applications may include, for example, instant messaging applications, email applications, telephone applications, and/or any other type of application for which notifications are displayed. In some embodiments, the predefined region may be, for example, a region that does not conflict with or occlude much of the display of virtual objects or content within the computer-generated environment, such as an upper region of the computer-generated environment 320C.

In some embodiments, in accordance with a determination that a representation of the sending user is not displayed by device 312 within the computer-generated environment 320C and/or a determination that the emitting location 326a is within a notifications region 330, the visual portion 324a (including one or more elements 352a) of the spatial effect is presented as having a first size that is different from (e.g., smaller than) a size of a visual portion 324 of the spatial effect that is presented when a representation of the sending user is visible within the computer-generated environment. For example, each element 352a of the visual portion 324a of the spatial effect may be smaller than each element 352 of the visual portion 324 of the spatial effect presented in the example of FIG. 3A. For example, the visual portion 324a (including all of the elements 352a) may be presented within a smaller area of the computer-generated environment relative to the example of FIG. 3A, such as by remaining within the notifications region 330.

In some embodiments, based on the satisfaction of various criteria, an identifier of a sending user may be presented with a spatial effect. In some embodiments, the identifier may be or may include a name of the sending user, a picture of the sending user, or another type of identifier of the sending user. For example, in FIG. 3B, an identifier 332 of a sending user (“Kirby”) is presented in the notifications region 330 with the spatial effect. Such an identifier 332 may be presented in response to a determination that a representation of the sending user is not displayed in the computer-generated environment 320C or when the emitting location of the spatial effect is not otherwise associated with (e.g., indicative of) a sending user. Presenting an identifier of a sending user with the spatial effect may indicate the identity of the sending user to the receiving user when the identity of the sending user is not otherwise clear based on, for example, the emitting location being near a representation of the sending user.

FIG. 3C illustrates an example of presenting a spatial effect in a computer-generated environment according to some examples of the disclosure.

In some embodiments, a user of device 312 may be directing their attention to (e.g., looking at and/or interacting with) a virtual object 334 within the computer-generated environment 320D. Virtual object 334 may be a static two-dimensional or three-dimensional virtual object, such as a virtual painting or virtual sculpture. Virtual object 334 may be a virtual display screen that is displaying an application, a user interface, and/or media content within the computer-generated environment 320D. For example, virtual object 334 may be a virtual display screen for displaying an instant messaging user interface that includes messaging conversations between the user of device 312 and one or more other users. For example, virtual object 334 may be a virtual display screen for displaying media content for viewing by the user of device 312.

The user's direction of attention may be determined by, for example, the use of eye-tracking software to determine a direction of the user's gaze within the computer-generated environment 320D, an orientation of device 312, user inputs to electronic device 312 that are associated with virtual object 334, and/or by other means of determination. In some embodiments, if a communication 303b associated with presenting a spatial effect is received by device 312 while the user's attention is directed to virtual object 334, the spatial effect may be presented with an emitting location and/or emitting direction that is selected, by device 312, based on the location of the virtual object 334 within the computer-generated environment 320D. For example, as shown in FIG. 3C, in response to receiving communication 303b and in accordance with a determination that the attention of a user of device 312 is directed to virtual object 334, the spatial effect may be presented with an emitting location that is within a threshold distance of virtual object 334 (such as within 0.1, 0.2, 0.3, 0.4, 0.5, 0.6, 0.7, 0.8, 0.9, or 1.0 meters above, behind, below, in front of, or adjacent to virtual object 334) and/or with an emitting direction that is toward virtual object 334.

In the example of FIG. 3C, device 312 has selected an emitting location of the visual portion 324b that is behind the virtual object 334 and an emitting direction that is upwards and towards the virtual object 334 such that the visual portion 324b spatial effect appears to originate behind virtual object 334 and traverse a path over the top of virtual object 334. (Representations of the emitting location and emitting direction are not depicted in FIG. 3C as they are behind virtual object 334.) Similarly, device 312 has selected an emitting location of an audio portion 328b of the spatial effect that is the same as the emitting location of the visual portion 324b.

In some embodiments, a representation of the spatial effect may be saved by device 312 for later playback. For example, if virtual object 334 is a display screen that is displaying a messaging conversation between the user of device 312 and a user that sent a spatial effect to the user of device 312 within an instant message (e.g., via an instant messaging application), device 312 may present the spatial effect when the user of device 312 initially views the instant message (e.g., by presenting the spatial effect as shown in FIGS. 3B-3F), and device 312 may save a representation of the spatial effect in the instant messaging history between the sending user and the user of device 312. The user of device 312 can subsequently go back in the instant messaging history and replay the spatial effect.

FIG. 3D illustrates an example of presenting a spatial effect in a computer-generated environment according to some examples of the disclosure.

The example depicted in FIG. 3D is an alternative to that depicted in FIG. 3C, in which the emitting location 326b of the visual portion 324c of the spatial effect and/or of an audio portion 328c is selected by device 312 to be above virtual object 334 in computer-generated environment 320D, and the emitting direction 350b is selected to be downwards toward virtual object 334 (e.g., such that the spatial effect appears to originate above the virtual object 334 and traverse a path down onto, in front of, and/or behind virtual object 334).

FIG. 3E illustrates an example of presenting a spatial effect in a computer-generated environment according to some examples of the disclosure.

In the example of FIG. 3E, a user of electronic device 312 is viewing or experiencing media content on a virtual screen 336 (e.g., a user interface for displaying content or applications) within the computer-generated environment 320E. The media content may be audio-visual content that changes over time, such as a movie or another type of audio-visual content. The user of electronic device 312 may be viewing or experiencing the media content alone, for example, or with one or more additional users of one or more electronic devices that are communicatively linked in a multi-user communication session as part of a shared virtual experience.

In other embodiments, in response to the electronic device 312 receiving a communication 303c associated with presenting a spatial effect, and in accordance with a determination that the user of device 312 is viewing the media content on virtual screen 336 (based on, for example, a detected gaze of the user and/or a detected activity level of a content-viewing user interface), the visual portion 324d of the spatial effect may be presented with an emitting location 326d that is within an area of virtual screen 336. In some embodiments, the visual portion 324d of the spatial effect may be overlaid with the content displayed on virtual screen 336.

In other embodiments, in accordance with a determination that the user of device 312 is viewing the media content on virtual screen 336, a visual portion of the spatial effect may be presented with a plurality of emitting locations and corresponding emitting directions that are selected by device 312 based on the location of the virtual screen 336. For example, a visual portion of the spatial effect may be presented with a plurality of emitting locations that lie along an interior or exterior perimeter of virtual screen 336 and a corresponding plurality of emitting directions such that elements of the visual portion of the spatial effect are directed toward the center of the virtual screen 336, downwards, or in another direction(s). As another example, a visual portion of the spatial effect may be presented with a plurality of emitting locations and a corresponding plurality of emitting directions that correspond to a plurality of corners of virtual screen 336, such that the spatial effect appears to be emitted from the corners of virtual screen 336.

Optionally, in accordance with the determination that a representation of the sending user is not displayed in computer-generated environment 320E and/or the determination that the user of device 312 is viewing the media content on virtual screen 336, an identifier 332a of the sending user (“Ben”) may be presented with the spatial effect.

Selecting an emitting location(s) and emitting direction(s) based on the location of virtual screen 336 may enable the receiving user to see the spatial effect without changing a direction of their gaze, for example, and therefore without unduly distracting the user from the content displayed on virtual screen 336.

FIG. 3F illustrates an example of presenting a spatial effect in a computer-generated environment according to some examples of the disclosure.

In some embodiments, content can be shared in a computer-generated environment while a first electronic device (e.g., device 310 described with reference to FIG. 3A) and a second electronic device (e.g., device 312) are communicatively linked in a multi-user communication session. In some embodiments, content that is viewed by one user at one electronic device (e.g., device 310) may be simultaneously viewed by another user at another electronic device (e.g., device 312) in the multi-user communication session.

In some embodiments, when a user of device 312 is participating in a multi-user communication session with a user of device 310 and is watching shared content (e.g., on a virtual screen 336) in a computer-generated environment 320F, the user of device 310 may be represented by an avatar (or other representation) in the computer-generated environment 320F displayed on device 312, such as by avatar 340.

In some embodiments, in response to receiving, by device 312 from device 310, a communication 303d associated with presenting a spatial effect while shared content is displayed in the computer-generated environment 320F and while a representation of the user of device 310 is displayed in the computer-generated environment 320F, device 312 selects visual attributes and/or audio attributes for presenting the spatial effect based on whether the user of device 312 is looking at the shared content or is looking at the representation of the user of device 310.

In some embodiments, as shown in FIG. 3F, in response to receiving a communication 303d associated with presenting a spatial effect from the user of device 310 while the user of device 312 is watching shared content with the user of device 310, and in accordance with a determination that a representation of the sending user (e.g., avatar 340) is in the line of sight 354 of the user of device 312 (e.g., the receiving user is looking at a representation of the sending user), device 312 may present a visual portion 324c of the spatial effect with an emitting location 326e that is selected by device 312 based on the location of the representation of the sending user, such as based on the location of avatar 340. For example, in some embodiments, device 312 may select an emitting location that is within a threshold (virtual) distance of the representation of the sending user, such as within 0.1, 0.2, 0.3, 0.4, 0.5, 0.6, 0.7, 0.8, 0.9, or 1.0 meters above, behind, below, in front of, or adjacent to avatar 340.

In some embodiments, in response to receiving communication 303d while shared content is displayed in the computer-generated environment 320F and in accordance with a determination that the receiving user (the user of device 312) is looking at the shared content, device 312 may present the spatial effect with visual attributes and/or audio attributes as described with reference to FIGS. 3B-3E, where virtual object 334 represents a virtual screen.

FIG. 3G illustrates an example of suppressing a spatial effect in a computer-generated environment according to some examples of the disclosure.

The example shown in FIG. 3G is an alternative to FIG. 3F, in which the receiving user is looking at the media content on virtual screen 336 instead of at avatar 340. That is, virtual screen 336 is in the line of sight 354 of the receiving user. In some embodiments, in response to receiving communication 303d and in accordance with a determination that the receiving user's attention is directed to content displayed on virtual screen 336, device 312 may temporarily or permanently suppress (e.g., delay or forgo) presentation of the spatial effect, such as by temporarily or permanently suppressing presentation of the visual portion of the spatial effect, the audio portion of the spatial effect, or both.

More broadly, it may be desirable for a receiving device 312 to suppress presentation of a spatial effect based on various criteria that may include, for example, whether a user is watching media content, whether a first type of application is active on the receiving device (e.g., whether the user of device 312 is viewing and/or interacting with a work-related or productivity-related application, such as a spreadsheet application, a word-processing application, a test-taking application, a presentation application, or a project-management application), whether device 312 is operating in a notification-suppression mode, and/or whether the user of device 312 is partially or fully immersed in a virtual environment. Each of these criteria may help indicate whether the receiving user is likely to want to see the spatial effect when the communication associated with presenting the spatial effect is received, or if the receiving user may not wish to be disturbed or distracted by presentation of the spatial effect.

A level of immersion (e.g., an immersion level) indicates a state and the amount in which an object (e.g., user interface objects, user interfaces, menus, selectable options, shapes, virtual objects, etc.) in a computer-generated environment is visually emphasized with respect to other objects in the environment, for the purpose of increasing the user's sense of immersion with the visually emphasized object. In some embodiments, an immersion level includes an associated degree to which the electronic device displays background content (e.g., content other than the respective user interface) around/behind the first respective user interface, optionally including the number of items of background content displayed and the visual characteristics (e.g., colors, contrast, opacity) with which the background content is displayed. In some embodiments, the background content is included in a background over which the first respective user interface is displayed. In some embodiments, the background content includes additional user interfaces (e.g., user interfaces generated by the device corresponding to applications other than the application of the respective user interface, system user interfaces), virtual objects (e.g., files, representations of other users, etc. generated by the device) not associated with or included in the respective user interface, and real objects (e.g., pass-through objects representing real objects in the physical environment of the electronic device that are displayed by the device such that they are visible via the display generation component). In some embodiments, at a first (e.g., low) level of immersion, the background, virtual and/or real objects are presented in an unobscured manner. For example, a respective user interface with a low level of immersion is displayed concurrently with the background content, which is displayed with full brightness, color, and/or translucency. In some embodiments, at a second (e.g., higher) level of immersion, the background, virtual and/or real objects are presented in an obscured manner (e.g., dimmed, blurred, removed from display, etc.). For example, a respective user interface with a high level of immersion is presented without concurrently presenting the background content (e.g., in a full screen or fully immersive mode). As another example, a user interface presented with a medium level of immersion is presented concurrently with darkened, blurred, or otherwise de-emphasized background content. In some embodiments, the visual characteristics of the background objects varies among the background objects. For example, at a particular immersion level, one or more first background objects are visually de-emphasized (e.g., dimmed, blurred, displayed with increased transparency) more than one or more second background objects and one or more third background objects cease to be presented.

In some embodiments, a spatial effect may be temporarily suppressed by device 312 while various criteria are satisfied (e.g., while the receiving device is operating in a notification-suppression mode, while a first type of application is active, while the user is viewing media content, while the user is fully immersed, etc.), and subsequently presented (e.g., automatically and/or in accordance with the examples depicted in FIGS. 3A-3F, 3H, or 3I) to the receiving user when the criteria are no longer satisfied. In some embodiments, in response to device 312 receiving a communication associated with a spatial effect while various criteria are satisfied, device 312 may suppress presentation of the spatial effect but may present a less-obtrusive notification associated with the communication, where presenting the less-obtrusive notification excludes presenting the spatial effect. In some embodiments, if the spatial effect is suppressed, the spatial effect may be subsequently presented by device 312 in response to detecting a user input that triggers presentation of the spatial effect, such as by detecting that the user is directing their attention to and/or interacting with an area or object in the computer-generated environment that is associated with presenting the spatial effect, such as to a notifications region (e.g., as shown in FIG. 3B), to a notification associated with the received communication, to a user interface associated with the received communication (e.g., an instant messaging user interface), or to a representation of the sending user. In some embodiments, detecting the input that triggers presentation of the spatial effect may include detecting that the receiving user is directing their attention to the area or object for a time threshold (e.g., a dwell time), such as for 0.5, 1, 1.5, 2, 2.5, 3, 3.5, 4, 4.5, or 5 seconds.

In some embodiments, presentation of a spatial effect may be suppressed in accordance with a determination that the receiving user is fully or mostly immersed in a virtual environment, such as a gaming environment. That is, in some embodiments, the criteria may include a criterion that is satisfied when an immersion level of the receiving device is greater than a first level, indicating that the receiving user is fully or mostly immersed in a virtual environment. Alternatively, in some embodiments, in accordance with a determination that an immersion level of the receiving device is greater than a first level and that a representation of the receiving user is displayed by device 312 within the computer-generated environment, device 312 may select an emitting location(s) that is near (e.g., within 0.1, 0.2, 0.3, 0.4, 0.5, 0.6, 0.7, 0.8, 0.9, or 1 meters of) the representation of the receiving user, such as near or around an avatar of the receiving user. For example, the spatial effect may be presented with an emitting location(s) that is near or around the hands of the receiving user's avatar.

FIG. 3H illustrates an example of presenting a spatial effect in a computer-generated environment according to some examples of the disclosure.

As previously discussed, in some embodiments, the criteria used to select the visual attributes of a spatial effect may include a current lighting characteristic of the computer-generated environment, such as a time of day associated with the computer-generated environment.

For example, as shown in FIG. 3H, in response to receiving a communication 303e associated with presenting a spatial effect and in accordance with a determination that a lighting characteristic of the computer-generated environment 320G corresponds to daytime lighting, device 312 presents the spatial effect in the computer-generated environment 320G with visual portion 324e having a first color attribute. Alternatively, as shown in FIG. 3I, in response to receiving communication 303e associated with presenting a spatial effect and in accordance with a determination that a lighting characteristic of the computer-generated environment 320G corresponds to nighttime lighting, the device 312 presents the spatial effect with visual portion 324f having a second color attribute different from the first color attribute.

In the examples of FIGS. 3H and 3I, device 312 presents the same type of spatial effect (a star shower) regardless of the lighting characteristic. In other embodiments, device 312 may, in response to receiving a communication associated with presenting a spatial effect, select a type of spatial effect to be presented based on a current lighting characteristic of the computer-generated environment and then present the spatial effect according to the selected type. For example, in response to receiving a communication associated with presenting a spatial effect and in accordance with a determination that a lighting characteristic corresponds to daytime lighting, device 312 may select a first type of spatial effect to be presented (such as confetti), and in accordance with a determination that a lighting characteristic corresponds to nighttime lighting, device 312 may select a second type of spatial effect to be presented (such as fireworks).

FIG. 3J illustrates an example of presenting a spatial effect in a computer-generated environment according to some examples of the disclosure. As previously discussed, the visual attributes of a spatial effect may include the size of the spatial effect, such as the size of the individual elements of the spatial effect and/or the size of the overall area or volume in which the spatial effect is presented.

For example, a spatial effect that includes confetti may be presented using different sizes of confetti and/or within a differently sized area depending on the locations of objects (e.g., virtual objects and/or computer-generated representations of physical objects) near the emitting location of the confetti spatial effect. That is, if a confetti spatial effect has an emitting location that is near (e.g., within 0.1, 0.2, 0.3, 0.4, 0.5, 0.6, 0.7, 0.8, 0.9, or 1 meters) a relatively small object, the confetti may be presented as having a smaller size than if the confetti is emitted near a larger object. In this manner, the size of the spatial effect may help to convey a sense of realistic proportions of the spatial effect relative to nearby objects and appear more realistic and natural to the user, thereby improving the user experience.

Thus, in some embodiments, the criteria used to select the visual attributes of a spatial effect include a size of virtual objects near the emitting location of the spatial effect. For example, as shown in FIG. 3J, in response to receiving a communication 303f associated with presenting a spatial effect and in accordance with a determination that a size of a first virtual object (e.g., representation 102′ of real-world table 102) in near the emitting location of the spatial effect within the computer-generated environment 320H is larger than a threshold area or volume, device 312 presents the spatial effect with visual portion 324g having a first size. Alternatively, as shown in FIG. 3K, in response to receiving a communication 303g associated with presenting a spatial effect and in accordance with a determination that a size of a second virtual object (e.g., computer-generated representation 104′ of real-world mug 104) near the emitting location of the spatial effect in the computer-generated environment 320I is smaller than a threshold area or volume, device 312 presents the spatial effect with visual portion 324h having a second size different from (e.g., smaller than) the first size.

FIG. 3L illustrates an example of presenting a spatial effect in a computer-generated environment according to some examples of the disclosure.

As previously discussed, the visual attributes of a spatial effect may include a persistence level of the spatial effect. The persistence level of the spatial effect may specify, for example, whether the spatial effect appears to interact with objects within the computer-generated environment, such as by appearing to make contact with and/or gather on objects in the computer-generated environment. In some embodiments, the persistence level of the spatial effect may be selected by the receiving device (e.g., device 312) based on the spatial characteristics of objects (e.g., whether the object is two-dimensional or three-dimensional) near the selected emitting location of the spatial effect. For example, if the emitting location(s) is near or around a two-dimensional virtual object, such as being near or around a virtual screen (e.g., virtual screen 336) or a user interface for an application, the spatial effect may be presented with a first persistence level in which the spatial effect does not appear to make contact with or gather on the two-dimensional virtual object. Instead, the spatial effect may fall (or otherwise move) around the two-dimensional virtual object without appearing to make contact. In contrast, if the emitting location(s) is near or around a three-dimensional object (e.g., a three-dimensional virtual object or a computer-generated representation of a physical object), the spatial effect may be presented with a second persistence level in which the spatial effect appears to make contact with and/or gather on the three-dimensional object.

For example, as depicted in FIG. 3L, in response to receiving a communication 303h associated with presenting a spatial effect, device 312 may select an emitting location with visual portion 324i that is above representation 102′ of real-world table 102, as described with reference to FIG. 3J. In accordance with a determination that representation 102′ of real-world table 102 is a three-dimensional object, device 312 may select a persistence level in which some or all of the elements of the spatial effect (e.g., element 352c) appear to gather on representation 102′ of real-world table 102 as they move within computer-generated environment 320H.

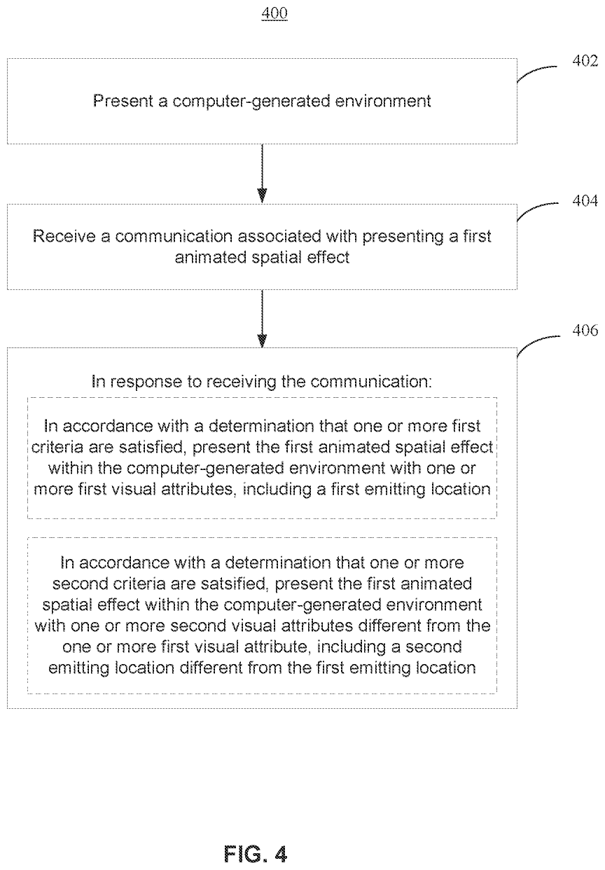

FIG. 4 illustrates a flow diagram illustrating an example process for presenting a spatial effect in a computer-generated environment at an electronic device according to some examples of the disclosure. In some embodiments, process 400 begins at a first electronic device in communication with a display. In some examples, the first electronic device is optionally a head-mounted display similar or corresponding to electronic device 101 of FIG. 1 or electronic device 200 of FIG. 2.

As shown in FIG. 4, in some embodiments, at 402, the first electronic device presents, via the display, a computer-generated environment. For example, the first electronic device presents a three-dimensional computer-generated environment, such as computer-generated environments 320A-320H described with reference to FIGS. 3A-3L.

In some embodiments, at 404, while displaying the computer-generated environment, the first electronic device receives, from a second electronic device, (e.g., via communication circuitry 222) a communication (e.g., communication 303-303h described with reference to FIGS. 3A-3L) associated with presenting a spatial effect. The communication may include only a request to present the spatial effect or may also include additional text or content.

In some embodiments, at 406, in response to receiving the communication associated with the spatial effect, the first electronic device may determine whether various criteria are satisfied and select one or more visual attributes for presenting the spatial effect in the computer-generated environment based on the criteria that are satisfied. The electronic device may then present the spatial effect in accordance with the selected visual attributes.

For example, in accordance with a determination that one or more first criteria are satisfied, the electronic device presents the first animated spatial effect within the computer-generated environment with one or more first visual attributes, including a first emitting location. The one or more first criteria may include one or more of the criteria described with reference to FIGS. 3A-3L, among other criteria described herein. The one or more first visual attributes may include, in addition to the first emitting location, one or more of: a first emitting direction, a first color, a first persistence level, and/or a first size of the spatial effect as described with reference to FIGS. 3A-3L.

For example, in accordance with a determination that one or more second criteria are satisfied, the electronic device presents the first animated spatial effect within the computer-generated environment with one or more second visual attributes different from the or more first visual attributes, including a second emitting location different from the first emitting location. The one or more second criteria may include one or more of the criteria described with reference to FIGS. 3A-3L, for example, among other criteria described herein. The second visual attributes may include, in addition to the second emitting location, one or more of: a second emitting direction, a second color, a second persistence level, and/or a second size of the spatial effect as described with reference to FIGS. 3A-3L.

It is understood that process 400 is an example and that more, fewer, or different operations can be performed in the same or in a different order. Additionally, the operations in process 400 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method performed at a first electronic device in communication with a display. In some examples, the method includes presenting, using the display, a computer-generated environment, and receiving, from a second electronic device, a communication associated with presenting a first animated spatial effect. In some examples, the method includes, in response to receiving the communication and in accordance with a determination that one or more first criteria are satisfied, presenting the first animated spatial effect within the computer-generated environment with one or more first visual attributes, where the one or more first visual attributes include a first emitting location of the first animated spatial effect. In some examples the method includes, in response to receiving the communication and in accordance with a determination that one or more second criteria are satisfied, presenting the first animated spatial effect within the computer-generated environment with one or more second visual attributes that are different from the one or more first visual attributes, where the one or more second visual attributes include a second emitting location of the first animated spatial effect that is different from the first emitting location.

In some examples, the one or more first criteria include a criterion that is satisfied when a representation of the user of the second electronic device is displayed in the computer-generated environment, and the first emitting location is based on a location of the representation of the user of the second electronic device in the computer-generated environment.

In some examples, the first emitting location is within a threshold distance of the representation of the user of the second electronic device.

In some examples, the one or more second criteria include a criterion that is satisfied when a representation of the user of the second electronic device is not displayed in the computer-generated environment, and the second emitting location corresponds to a notifications region in the computer-generated environment.

In some examples, the one or more first visual attributes include a first size of the first animated spatial effect, and the one or more second visual attributes include a second size of the first animated spatial effect different than the first size.

In some examples, the method includes selecting the first size of the first animated spatial effect based on the first emitting location.

In some examples, the one or more first visual attributes include a first color attribute of the first animated spatial effect, and the one or more second visual attributes include a second color attribute of the first animated spatial effect different from the first color attribute.

In some examples, the one or more first criteria include a criterion that is satisfied when a user immersion level is greater than a first immersion level, and the one or more second criteria include a criterion that is satisfied when the user immersion level is not greater than the first immersion level.

In some examples, the method includes, in accordance with the determination that the one or more first criteria are satisfied, presenting the first animated spatial effect within the computer-generated environment with one or more first audio attributes, and in accordance with the determination that the one or more second criteria are satisfied, presenting the first animated spatial effect within the computer-generated environment with one or more second audio attributes that are different from the one or more first audio attributes.

In some examples, the one or more first audio attributes include a first audio emitting location and the one or more second audio audible attributes include a second audio emitting location different than the first audio emitting location.

In some examples, presenting the computer-generated environment includes displaying a user interface for displaying content for viewing in the computer-generated environment by the user of the first electronic device, and the one or more first criteria include a criterion that is satisfied when an attention of the user of the first electronic device is directed to the user interface for displaying the content for viewing within the computer-generated environment.

In some examples, the method includes, in accordance with the determination that the one or more first criteria are satisfied, selecting the first emitting location based on a location of the user interface for displaying the content for viewing in the computer-generated environment.

In some examples, presenting the computer-generated environment includes displaying a representation of the user of the second electronic device, and the one or more second criteria include a criterion that is satisfied when an attention of the user of the first electronic device is directed to the representation of the second user.

In some examples, the method includes, in accordance with the determination that the one or more second criteria are satisfied, selecting the second emitting location based on a location of the representation of the second user.

In some examples, the method includes, in accordance with a determination that one or more third criteria are satisfied, suppressing presentation of the first animated spatial effect.

In some examples, the one or more third criteria include a criterion that is satisfied when the first electronic device is operating in notification-suppression mode.

In some examples, the one or more third criteria include a criterion that is satisfied when a first type of application is active.

In some examples, the method includes receiving, from a third electronic device, a communication associated with presenting a second animated spatial effect. In some examples, the method includes, in response to receiving the communication associated with presenting the second animated spatial effect and in accordance with a determination that one or more fourth criteria are satisfied, presenting the second animated spatial effect within the computer-generated environment with one or more third visual attributes. In some examples, the method includes, in response to receiving the communication and in accordance with a determination that one or more fifth criteria are satisfied, presenting the second animated spatial effect within the computer-generated environment with one or more fourth visual attributes that are different from the one or more third visual attributes.

Some examples of the disclosure are directed to an electronic device, comprising one or more processors, memory, and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the invention to the precise forms disclosed. Many modifications and variations are possible in view of the above teachings. The examples were chosen and described in order to best explain the principles of the invention and its practical applications, to thereby enable others skilled in the art to best use the invention and various described examples with various modifications as are suited to the particular use contemplated.

What is claimed is:

1. A method comprising:
at a first electronic device in communication with a display:
presenting, using the display, a computer-generated environment;
receiving, from a second electronic device, a communication associated with presenting a first animated spatial effect; and
in response to receiving the communication:
in accordance with a determination that one or more first criteria are satisfied, presenting the first animated spatial effect within the computer-generated environment with one or more first visual attributes, the one or more first visual attributes including a first emitting location of the first animated spatial effect; and
in accordance with a determination that one or more second criteria are satisfied, presenting the first animated spatial effect within the computer-generated environment with one or more second visual attributes, different from the one or more first visual attributes, the one or more second visual attributes including a second emitting location of the first animated spatial effect, different from the first emitting location.

2. The method of claim 1,
wherein:
the one or more first criteria include a criterion that is satisfied when a representation of a user of the second electronic device is displayed in the computer-generated environment, and
the first emitting location is based on a location of the representation of the user of the second electronic device in the computer-generated environment.

3. The method of claim 2, wherein the first emitting location is within a threshold distance of the representation of the user of the second electronic device.

4. The method of claim 1, wherein:
the one or more second criteria include a criterion that is satisfied when a representation of a user of the second electronic device is not displayed in the computer-generated environment; and
the second emitting location corresponds to a notifications region in the computer-generated environment.

5. The method of claim 1, wherein the one or more first visual attributes comprise a first size of the first animated spatial effect, and the one or more second visual attributes comprise a second size of the first animated spatial effect different than the first size.

6. The method of claim 5, further comprising:
selecting the first size of the first animated spatial effect based on the first emitting location.

7. The method of claim 1, wherein the one or more first visual attributes comprise a first color attribute of the first animated spatial effect, and the one or more second visual attributes comprise a second color attribute of the first animated spatial effect different from the first color attribute.

8. The method of claim 1, wherein:
the one or more first criteria include a criterion that is satisfied when a user immersion level is greater than a first immersion level; and
the one or more second criteria include a criterion that is satisfied when the user immersion level is not greater than the first immersion level.

9. The method of claim 1, further comprising:
in accordance with the determination that the one or more first criteria are satisfied, presenting the first animated spatial effect within the computer-generated environment with one or more first audio attributes, and
in accordance with the determination that the one or more second criteria are satisfied, presenting the first animated spatial effect within the computer-generated environment with one or more second audio attributes, different from the one or more first audio attributes.

10. The method of claim 9, wherein:
the one or more first audio attributes comprise a first audio emitting location and the one or more second audio audible attributes comprise a second audio emitting location different than the first audio emitting location.

11. The method of claim 1, wherein:
presenting the computer-generated environment comprises displaying a user interface for displaying content for viewing in the computer-generated environment by a user of the first electronic device; and
the one or more first criteria include a criterion that is satisfied when an attention of the user of the first electronic device is directed to the user interface for displaying the content for viewing within the computer-generated environment, the method further comprising:
in accordance with the determination that the one or more first criteria are satisfied, selecting the first emitting location based on a location of the user interface for displaying the content for viewing in the computer-generated environment.

12. The method of claim 11, wherein:
presenting the computer-generated environment comprises displaying a representation of a user of the second electronic device; and
the one or more second criteria include a criterion that is satisfied when an attention of the user of the first electronic device is directed to the representation of the second user, the method further comprising:
in accordance with the determination that the one or more second criteria are satisfied, selecting the second emitting location based on a location of the representation of the second user.

13. The method of claim 1, further comprising:
in accordance with a determination that one or more third criteria are satisfied, suppressing presentation of the first animated spatial effect.

14. The method of claim 13, wherein the one or more third criteria include a criterion that is satisfied when the first electronic device is operating in notification-suppression mode.

15. The method of claim 13, wherein the one or more third criteria include a criterion that is satisfied when a first type of application is active.

16. The method of claim 1, further comprising:
receiving, from a third electronic device, a communication associated with presenting a second animated spatial effect; and
in response to receiving the communication associated with presenting the second animated spatial effect:
in accordance with a determination that one or more fourth criteria are satisfied, presenting the second animated spatial effect within the computer-generated environment with one or more third visual attributes, and
in accordance with a determination that one or more fifth criteria are satisfied, presenting the second animated spatial effect within the computer-generated environment with one or more fourth visual attributes, different from the one or more third visual attributes.

17. An electronic device, comprising:
a display; and
a controller configured to cause the electronic device to:
present, using the display, a computer-generated environment;
receive, from a second electronic device, a communication associated with presenting a first animated spatial effect; and
in response to receiving the communication:
in accordance with a determination that one or more first criteria are satisfied, present the first animated spatial effect within the computer-generated environment with one or more first visual attributes, the one or more first visual attributes including a first emitting location of the first animated spatial effect; and
in accordance with a determination that one or more second criteria are satisfied, present the first animated spatial effect within the computer-generated environment with one or more second visual attributes, different from the one or more first visual attributes, the one or more second visual attributes including a second emitting location of the first animated spatial effect, different from the first emitting location.

18. A non-transitory computer readable storage medium storing one or more programs, the one or more programs comprising instructions, which when executed by a controller of an electronic device in communication with a display, cause the electronic device to:
present, using the display, a computer-generated environment;
receive, from a second electronic device, a communication associated with presenting a first animated spatial effect; and
in response to receiving the communication:
in accordance with a determination that one or more first criteria are satisfied, present the first animated spatial effect within the computer-generated environment with one or more first visual attributes, the one or more first visual attributes including a first emitting location of the first animated spatial effect; and
in accordance with a determination that one or more second criteria are satisfied, present the first animated spatial effect within the computer-generated environment with one or more second visual attributes, different from the one or more first visual attributes, the one or more second visual attributes including a second emitting location of the first animated spatial effect, different from the first emitting location.
